(19) United States
(12) Patent Application Publication
(10) Pub. No.: US 2016/0361652 A1
(43) Pub. Date: Dec. 15, 2016

(54) SYSTEM AND METHOD FOR ACCURATELY ESTIMATING A FANTASY FOOTBALL TEAMS PERFORMANCE

(71) Applicant: Donald Russell, Lexington Park, MD (US)

(72) Inventor: Donald Russell, Lexington Park, MD (US)

(21) Appl. No.: 14/734,363

(22) Filed: Jun. 9, 2015

(51) Int. Cl. A63F 13/65; A63F 13/46; A63F 13/58; A63F 13/828; A63F 13/795

(52) U.S. Cl. CPC A63F 13/65; A63F 13/828; A63F 13/795; A63F 13/58; A63F 13/46

(57) ABSTRACT

The present invention relates to a system and method for accurately estimating the fantasy football team's performance based on the individual player's performance in a fantasy football game series. The method tracks the performance of each player in the fantasy football series by positioning each player in various locations and evaluates the team's performance based on the individual player's performance by aligning the players at different locations. Further, the method evaluates the team's performance by tracking the individual player's performance in the fantasy football game series played in real-time for a specific period of time. Further, the method aims to create balanced teams that depict a high winning rate statistics.

### FIELD OF THE INVENTION

The present invention generally relates to estimating a fantasy football team's performance and more particularly relates to estimating a fantasy football team's performance through a website by drafting multiple teams from a roster team and evaluating the performance of the drafted teams based on the performance of individual players participating in the real-time fantasy football game series.

### BACKGROUND OF THE INVENTION

Currently, there are many fantasy football sports playing websites available in the market. The existing fantasy football sports playing web site allows the user(s) to evaluate the team's statistics based on the actual scoring statistics associated with the actual sport. However, the method of evaluating the performance of player is not very accurate based on which the team's statistics is determined. Hence, the drafted team does not guarantee a high winning statistics with the chosen players. In order to closely or accurately evaluate the drafted team's performance, there is a need to evaluate individual player's performance by adopting a complex scoring system. The complex scoring system must allow the user(s) to accurately estimate the team's performance and accordingly assist the user(s) in drafting team(s) with high winning statistics.

Hence, there is a need for a complex scoring system that allows the user(s) to accurately estimate the drafted team's performance and to recommend a team lineup that depicts a high winning statistics.

### SUMMARY OF THE INVENTION

The present invention relates to a system and method for accurately estimating the fantasy football game team's performance through a website for one or more registered users, wherein the system comprises of drafting at least sixteen teams from a roster of sixty players by evaluating each player's performance, associated with one or more teams, and considering at least three consecutive league matches played by each player in real-time. The system implements a new scoring method to evaluate individual player's performance and computes a score for the player(s) as the player(s) crosses a minimum of 100 yards while playing the fantasy football game series in real-time. Further, the system provides a means to determine the overall performance of the teams by drafting a balanced team based on the performance of the player(s) participating in the fantasy football game series in real-time. Further, the system provides a means to list the players for replacing the player(s) who are injured while participating in the fantasy football game series in real-time.

### BRIEF DESCRIPTION OF DRAWINGS

FIG. 1 illustrates a working overview of the system 100 used for accurately estimating the fantasy football team's performance.

FIG. 2 illustrates a flow-chart 200 that explains the method for accurately estimating the fantasy football team's performance.

FIG. 3 illustrates a flow-chart 300 that explains the method of implementing a scoring system to draft a balanced team through the website.

FIG. 4 illustrates a screen-shot of various positions occupied by the players for determining the individual player's performance.

FIG. 5 illustrates a system overview of components 500 used to implement the method for accurately estimating the fantasy football team's performance.

### FIGURE DESCRIPTION

100—A system overview
101—A fantasy football website for implementing the method for accurately estimating the fantasy football team's performance
102—A user interacting with the fantasy football website
103—A performance report delivered by the fantasy football website
104—A real-time tracking system feeding real-time inputs into the fantasy football website
200—A process that explains the method for accurately estimating the fantasy football team's performance.
300—A process that explains the implementation of the scoring system for evaluating individual player's performance.
500—A system overview of components used for implementing the method for accurately estimating the fantasy football team's performance.
501—A registration module
502—A drafting module
503—A storage module
504—An analyzing module
505—A notification module
506—A controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

The terms fantasy football website and website are used interchangeably throughout the document.

In an embodiment, the term user refers to the user who has registered with the fantasy football website 101. Further, the fantasy football website 101 is configured to run on any electronic device that is capable of processing and analyzing the data for estimating the fantasy football team's performance. For example, the electronic device can be a mobile phone, a laptop, a personal computer, a smart phone, or the like.

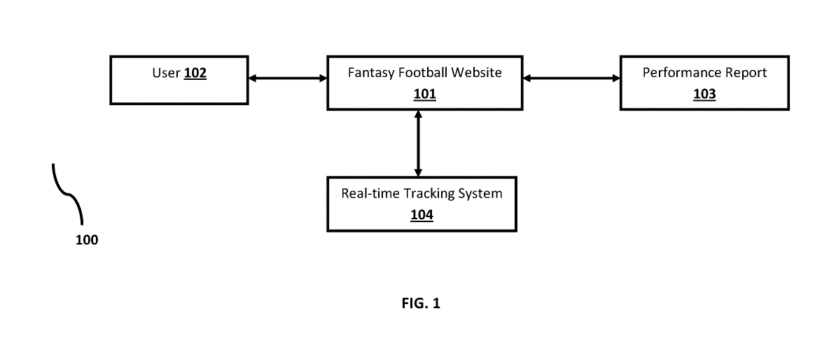

Referring to FIG. 1 illustrates a working overview of the system 100 for accurately estimating the fantasy football team's performance. In an embodiment, the fantasy football website 101 accepts the rules from the user 102 for the league matches and a roster team comprising of 60 members from which at least sixteen teams are to be drafted. In an embodiment, the system 100 accepts the real-time performance of the players from the Real-time tracking system 104. The real-time tracking system 104 is configured to track the player's performance in the football game that is in progress and to gather inputs regarding the game. Further, the gathered inputs will be fed into the fantasy football website 101. In another embodiment, the football game can be tracked by the user 102 in real-time and the user 102 can feed-in the tracked inputs into the fantasy football website 101 for further analysis.

In an embodiment, based on the rules provided by the user 102 and the performance of the players evaluated in the football game series, the fantasy football website 101 analyzes the inputs and assists the user 102 to draft at least sixteen teams. The real-time performance of the players is evaluated by monitoring the performance of the players in all the game series played during three consecutive league matches. In an embodiment, based on the analysis performed by the fantasy football website 101, the system 100 creates at least sixteen teams that are balanced and the team statistics must demonstrate a high rate of winning the matches. In an embodiment, the teams drafted by the fantasy football website 101 can be an offensive team or a defensive team.

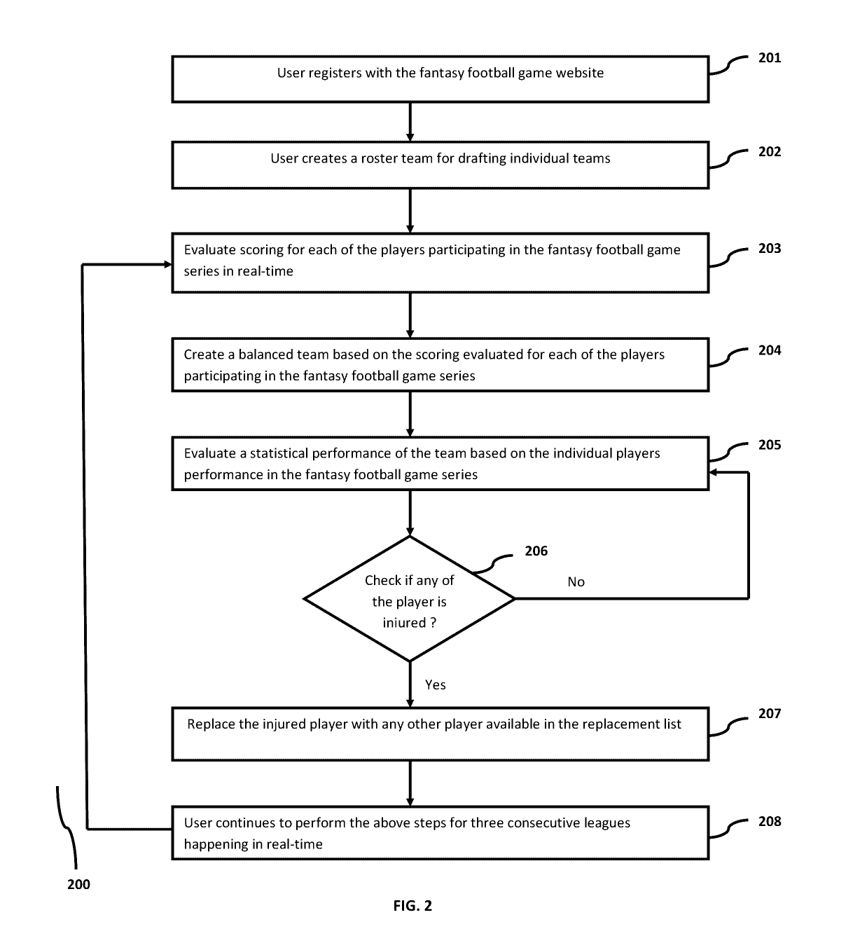

Referring to FIG. 2 illustrates a flow-chart 200 that explains the method for accurately estimating the fantasy football team's performance. Initially, at step 201, the method 200 allows the user 102 to register with the website 201. Upon successfully registering with the website 201, at step 202, the method 200 allows the user 102 to create a roster team comprising of 60 members. In an embodiment, the website 201 creates at least sixteen teams from the roster team after analyzing the real-time tracked inputs. At step 203, the method 200 evaluates the scoring of each player participating in the fantasy football game series. In an embodiment, the method 200 implements a scoring system by positioning each of the players in different locations and tracking their performance based on their positions. Further, the scoring system introduces a new rule that when the player crosses a minimum of 100 yards then the scoring of the player gets incremented. At step 204, the method 200 creates balanced teams based on the scoring evaluated for each of the player participating in the fantasy football game in real-time. At step 205, the method 200 evaluates the drafted team's performance based on each of the player's performance in the fantasy football game series played in real-time. At step 206, the method 200 checks if any of the player participating in the real-time fantasy football game series is injured. In an embodiment, the website 201 maintains a list of players who can be considered for replacing injured player(s). If the method 200 determines that the player is injured while playing the fantasy football game series then at step 207, the injured player is replaced with the player(s) listed in the website 201. Otherwise, the method 200 continues to evaluate the performance of the player(s) in the real-time fantasy football game series. In an embodiment, the method 200 does not allow the injured player(s) to participate in any other fantasy football game series played within a league and the method 200 evaluates the team's performance by considering the injured player(s) participation in the fantasy football game series. At step 208, the method 200 continues to evaluate the team's performance following the steps listed above for three consecutive league matches.

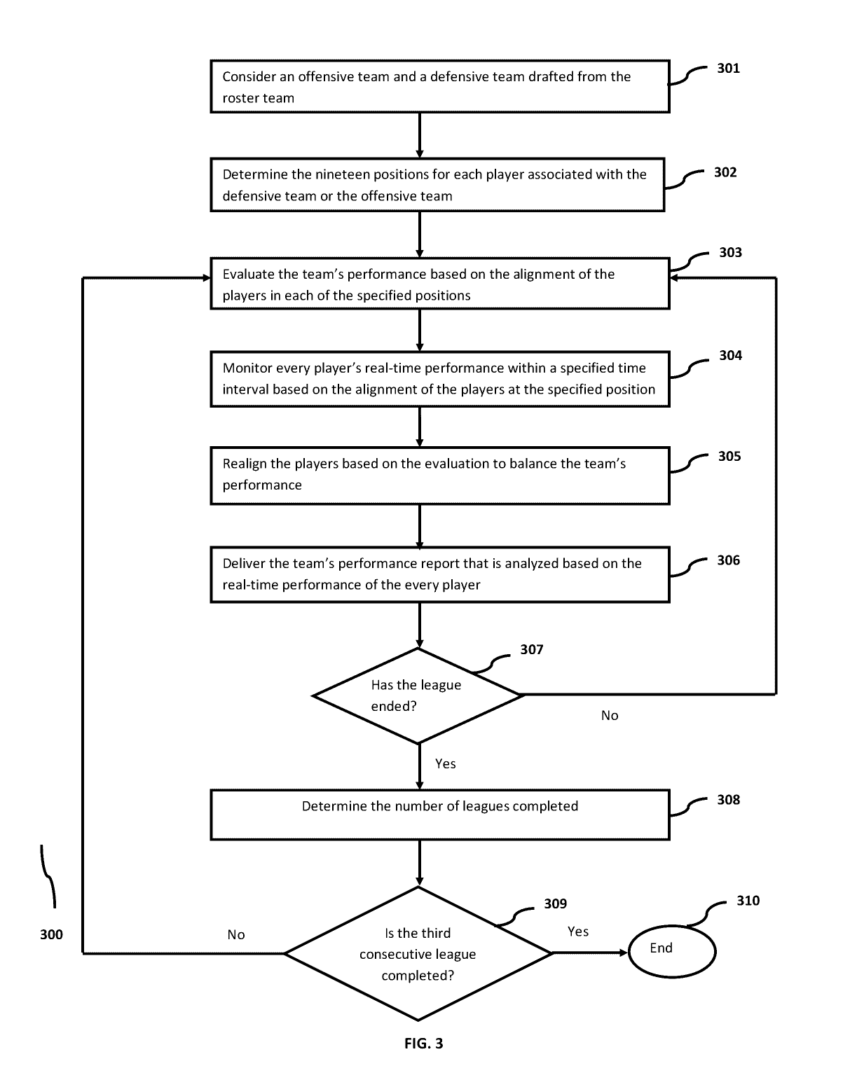

Referring to FIG. 3 illustrates a flow-chart 300 that explains the method 300 of implementing a scoring system to draft a balanced team through the website 101. Initially, at step 301, the method 300 considers one or more offensive teams and one or more defensive teams participating in real-time fantasy football game series. At step 302, the method 300 determines nineteen positions for aligning the players in each of these positions to form a team structure. For example, the nineteen positions can comprise of positions defined for offensive team as well as defensive team. The offensive team positions include 1 Quarterback/2 Running back/2 wide receivers/1 tight end/1 team kicker/1 special teams, and the defensive team positions include 4 defensive linemen/4 defensive linebackers/4 defensive backs. At step 303, the method 300 evaluates the team's performance by implementing the scoring system by evaluating each of the player's performance when assigned at a specific position. At step 304, the method 300 monitors every player's performance in real-time as the player is assigned at specific positions for a pre-specified period of time. For example, Player A can be assigned with Quarter back position for one week and his performance in real-time can be evaluated for one week. If Player A scores low on throwing quarter back intercepts then Player A can be assigned with a strong defensive player. Again based on Player A′s performance with the next defensive player, the rating or scoring for Player A can be determined more accurately. Accordingly, rating or scoring of each player's performance can be determined based on the performance of the player. At step 305, the method 300 realigns the players based on the performance scoring evaluated for each of the players participating in the real-time fantasy football game. For example, if Player A is scoring high as wide receiver in the subsequent matches as compared to his quarter back score then Player A can be considered as a wide receiver in the drafted team. At step 306, the method 300 delivers the team's performance report based on the analysis carried out on the real-time performance of each player participating in the real-time fantasy football game. At step 307, the method 300 determines the league status. If the league has ended then at step 308, the method 300 determines the number of leagues completed for evaluating the performance. Otherwise, the method 300 continues to monitor the fantasy football games until the league ends. At step 309, the method 300 determines the number of consecutive leagues completed. For example, if three consecutive leagues are completed, then at step 310 the method 300 terminates the performance evaluation associated with the league matches. Otherwise, the method 300 continues to evaluate the performance of the team based on the individual player's performance for three consecutive leagues.

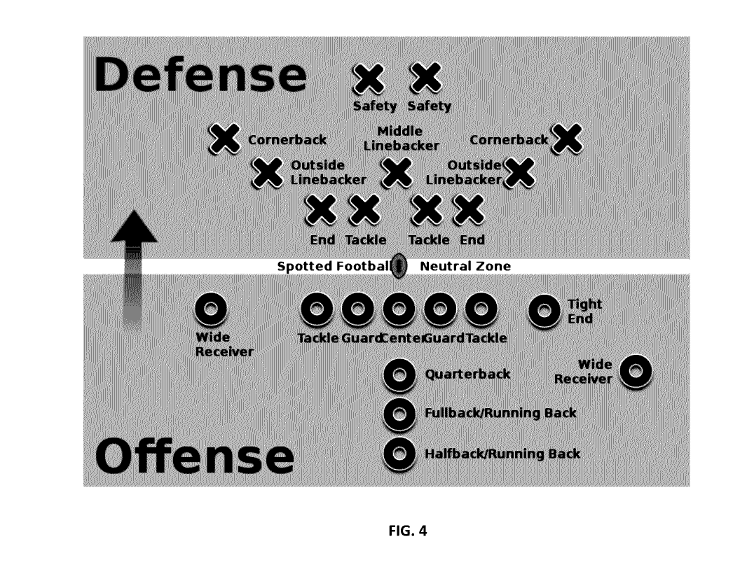

Referring to FIG. 4 illustrates a screen-shot of various positions occupied by the players for determining the individual player's performance. As depicted in the figure, the offensive players and defensive players are positioned at various points within the football ground. The offensive players can be positioned at 1 quarter back position, 2 wide receiver positions, 1 team kicking, 2 running back positions, and 1 special team position. Further, the defensive players can be 4 defensive linemen, 4 defensive linebackers, and 4 defensive backs.

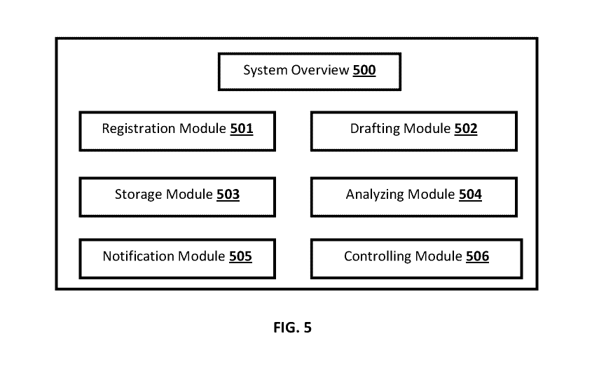

Referring to FIG. 5 illustrates a system overview 500 of components used to implement the system 100 for accurately estimating the fantasy football team's performance through the fantasy football website 101, wherein the system comprises of the following components: a Registration module 501, a Drafting module 502, a Storage module 503, an Analyzing module 504, a Notification module 505, and a Controlling module 506. In an embodiment, the Registration module 501 is configured to register the user(s) 102 with the fantasy football website 101. In an embodiment, the Drafting module 502 is configured to draft one or more fantasy football teams based on the performance evaluated for individual players playing in the fantasy football league. In an embodiment, the Storage module 503 is configured to store the evaluated data of the individual players and the team's performance evaluated based on the individual player's contribution. In an embodiment, the Analyzing module 504 is configured to analyze the collected performance data to evaluate the team's performance. In an embodiment, the Notification module 505 is configured to notify the performance report to the user 102 based on the analysis of the performance data collected from the fantasy football game series played in real-time. In an embodiment, the Controlling module 506 is configured to transfer data across various modules supported in the system 100.

1. A system and method for accurately estimating at least one drafted fantasy football game team's performance initiated on a website for at least one registered user, wherein said system comprises of:
a means to draft at least sixteen teams from a roster of sixty players;
a means to evaluate each player's performance, associated with at least one team, based on three consecutive league matches played by each said player in real-time;
a means to evaluate each said player's performance by implementing a scoring system;
a means to determine the performance of said at least one drafted fantasy football game team by evaluating each said player's performance in at least one fantasy football game series played in real-time; and
a means to provide a list of players for replacing each said player after getting injured while participating in said at least one fantasy football game series played in real-time.

2. The system as claimed in claim 1, wherein said means to draft said at least sixteen teams from a roaster of sixty players comprises of drafting a balanced team by considering the performance of each said player participating in said at least one fantasy football game series in real-time.

3. The system as claimed in claim 1, wherein said fantasy football game series comprises of a plurality of games played for a league.

4. The system as claimed in claim 2, wherein said at least sixteen teams that are drafted comprises of both at least one offensive team and at least one defensive team.

5. The system as claimed in claim 1, wherein each said player being replaced after getting injured while participating in said at least one fantasy football game series will be excluded from playing any other game scheduled within the league.

6. The system as claimed in claim 1, wherein the system is configured to implement said scoring system by:
considering an offensive team and a defensive team drafted from a roster team;
determining nineteen positions for each said player participating in said at least one fantasy football game series, wherein each said player is associated with one of: said offensive team, said defensive team;
evaluating each said player's performance after aligning each said player in a specified position;
monitoring each said player's performance within a specified time-interval after aligning each said player in said specified position;
delivering said at least one team's performance report after evaluating each said player's performance associated with said at least one team; and
realigning each said player's position to balance the performance report of said at least one team drafted by said registered user.

7. The system as claimed in claim 6, wherein said scoring system is configured to compute a score for each said player as each said player crosses a minimum of 100 yards while playing in said at least one fantasy football game series in real-time.

8. A method for accurately estimating at least one drafted fantasy football game team's performance initiated on a website for at least one registered user, wherein said method comprises of:
drafting at least sixteen teams from a roster of sixty players;
evaluating each player's performance, associated with at least one team, based on three consecutive league matches played by each said player in real-time;
evaluating each said player's performance by implementing a scoring system;
determining the performance of said at least one drafted fantasy football game team by evaluating each said player's performance in said at least one fantasy football game series played in real-time; and
providing a list of players for replacing each said player after getting injured while participating in said at least one fantasy football game series played in real-time.

9. The method as claimed in claim 8, wherein drafting said at least sixteen teams from a roaster of sixty players comprises of designing a balanced team that is determined based on the performance of each said player participating in said at least one fantasy football game series in real-time.

10. The method as claimed in claim 8, wherein said at least one fantasy football game series comprises of a plurality of games played for a league.

11. The method as claimed in claim 9, wherein said at least sixteen teams that are drafted comprises of both at least one offensive team and at least one defensive team.

12. The method as claimed in claim 9, wherein each said player being replaced after getting injured while participating in said at least one fantasy football game series will be excluded from playing any other game scheduled within the league.

13. The method as claimed in claim 8, wherein the method implements said scoring system by:
considering an offensive team and a defensive team drafted from a roster team;
determining nineteen positions for each said player participating in said at least one fantasy football game series, wherein each said player is associated with one of: said offensive team, said defensive team;
evaluating each said player's performance after aligning each said player in a specified position;
monitoring each said player's performance within a specified time-interval after aligning each said player in said specified position;
delivering said at least one team's performance report after evaluating each said player's performance associated with said at least one team; and
realigning each said player's position to balance the performance report of said at least one team drafted by said registered user.

14. The method as claimed in claim 13, wherein the method implements the scoring system by computing a score for each said player as each said player crosses a minimum of 100 yards while playing in said at least one fantasy football game series in real-time.
